(19) United States
(12) Patent Application Publication
(10) Pub. No.: US 2020/0342766 A1
(43) Pub. Date: Oct. 29, 2020

(54) DYNAMIC PLATOON MANAGEMENT

(71) Applicant: Cisco Technology, Inc., San Jose, CA (US)

(72) Inventors: Srinath Gundavelli, San Jose, CA (US); Vimal Srivastava, Bangalore (IN); Pradeep Kumar Kathail, Los Altos, CA (US)

(21) Appl. No.: 16/393,246

(22) Filed: Apr. 24, 2019

(51) Int. Cl. G08G 1/00; G05D 1/02; H04W 4/40; H04W 4/02; H04W 8/08

(52) U.S. Cl. CPC G08G 1/22; G08G 1/20; G05D 1/0295; G05D 2201/0213; H04W 4/02; H04W 8/08; H04W 4/40

(57) ABSTRACT

Techniques are described herein for dynamic platoon management. The techniques may include obtaining dynamic location data of a vehicle, where the dynamic location data indicates a current or predicted location of the vehicle. Based on the dynamic location data, a platoon of vehicles that is optimal for the vehicle to join may be identified. The vehicle may be dynamically joined to the platoon.

### TECHNICAL FIELD

The present disclosure relates to Vehicle-to-Everything (V2X) communications.

### BACKGROUND

The purpose of existing specifications relating to Vehicle-to-Everything (V2X) is to facilitate vehicular communications to support several communication modes, including Vehicle-to-Vehicle (V2V), Vehicle-to-Infrastructure (V21), Vehicle-to-Network (V2N), and Vehicle-to-Pedestrian (V2P). These communications modes are intended to provide intelligent services to end users and to enable a suite of vehicular applications for next-generation road infrastructure. Leveraging V2X support, vehicles and infrastructure elements can monitor local environmental conditions and share that information with the other vehicles and network elements in proximity.

### BRIEF DESCRIPTION OF THE DRAWINGS

FIG. 1 is a block diagram of a Fifth Generation (5G) mobile wireless system for dynamic platoon management, according to an example embodiment.

FIGS. 2A-2C illustrate portions of the system of FIG. 1 relating to vehicular communication, according to an example embodiment.

FIG. 3 illustrates a system configured for a first use case for dynamic platoon management, according to an example embodiment.

FIGS. 4A and 4B together provide a call flow diagram illustrating operations for the first use case for dynamic platoon management, according to an example embodiment.

FIG. 5 illustrates a system configured for a second use case for dynamic platoon management, according to an example embodiment.

FIG. 6 is another block diagram of a 5G mobile wireless system for dynamic platoon management, according to an example embodiment.

FIG. 7 is a block diagram a Fourth Generation (4G) mobile wireless system for dynamic platoon management, according to an example embodiment.

FIG. 8 illustrates a system configured for a third use case for dynamic platoon management, according to an example embodiment.

FIG. 9 illustrates a system configured for a fourth use case for dynamic platoon management, according to an example embodiment.

FIG. 10 is a block diagram of a computing device configured to execute dynamic platoon management operations, according to an example embodiment.

FIG. 11 is a flowchart of a method for dynamic platoon management, according to an example embodiment.

### DESCRIPTION OF EXAMPLE EMBODIMENTS

### Overview

Techniques are described herein for dynamic platoon management. The techniques may include obtaining dynamic location data of a vehicle, where the dynamic location data indicates a current or predicted location of the vehicle. Based on the dynamic location data, a platoon of vehicles that is optimal for the vehicle to join may be identified. The vehicle may be dynamically joined to the platoon.

### Example Embodiments

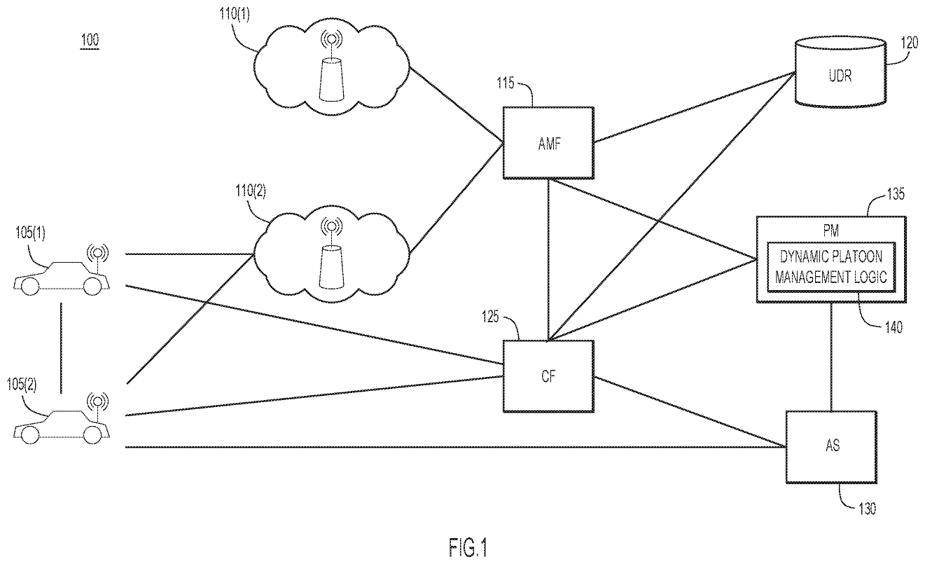

FIG. 1 illustrates an example 5G system 100 configured for dynamic platoon group formation. System 100 includes vehicles 105(1) and 105(2), each of which is configured to communicate with gNodeBs (gNBs) 110(1) and 110(2). System 100 further includes Access and Mobility Management Function (AMF) 115, Unified Data Repository (UDR) 120, Control Function (CF) 125, and Application Server (AS) 130.

Vehicles 105(1) and 105(2) may include or contain mobile wireless User Equipment (UE), and may include respective Vehicle-to-Everything (V2X) software applications to enable V2X operations. Vehicles 105(1) and 105(2) may belong to the same enterprise, different enterprises, private users/individuals, etc. gNBs 110(1) and 110(2) may be configured to perform base station functions on behalf of the 5G network in accordance with Evolved Universal Terrestrial Radio Access Network (EUTRAN) standards.

AMF 115 is configured to perform access and mobility management functions on behalf of the 5G network, such as authentication and security association based on subscription information. AMF 115 may also manage handover when vehicles 105(1) and 105(2) move from, e.g., gNB 110(1) to gNB 110(2). UDR 120 stores the subscription information and platooning configuration information.

CF 125 is configured to perform network-related actions used for techniques described herein for V2X operations. For example, CF 125 may maintain provisioning and configuration information to deliver information about which radio spectrum to use. CF 125 may be part of a policy function in a 5G network. AS 130 may deliver data to vehicles 105(1) and 105(2), configure Multimedia Broadcast Multicast Services (MBMS), and perform other application-specific Vehicle-to-Everything (V2X) features. AS 130 may include application logic to enable AS 130 to communicate with vehicles 105(1) and 105(2).

Platooning enables vehicles 105(1) and 105(2) to travel together in a group. In one example, vehicle 105(1) is the leader of the platoon, and provides data to vehicle 105(2) to enable vehicles 105(1) and 105(2) to carry out platoon operations. For example, the distance/time between vehicles 105(1) and 105(2) may become extremely small (e.g., less than one second). Platooning applications may also allow vehicle 105(2) to track vehicle 105(1) and be autonomously driven. In a further example, vehicle 105(1) may communicate with the 5G network on behalf of both vehicles 105(1) and 105(2).

Currently, there is no complete solution for dynamic management of platoons. For example, if vehicles 105(1) and 105(2) are not initially in the same platoon, but happen to be traveling in the same direction at the same time, vehicles 105(1) and 105(2) would not be able dynamically form a platoon to enjoy the advantages of platooning discussed above. Accordingly, Platoon Manager (PM) 135 is configured with dynamic platoon group formation logic 140.

Dynamic platoon management logic 140 enables PM 135 to perform operations associated with dynamic platoon management, including dynamic platoon formation, assignment, splitting, disbanding, leader designation, etc. Briefly, PM 135 may perform operations according to dynamic platoon management logic 140 based on information from vehicles 105(1) and 105(2) and subscription information (e.g., whether vehicles 105(1) and 105(2) are associated with the same enterprise). Dynamic platoon management logic 140 may serve as the basis of many dynamic platooning use cases, and may be implemented as a standardized or vendor-specific solution.

In one example, vehicles 105(1) and 105(2) attach to the 5G network (e.g., by wirelessly connecting to gNB 110(2)). Vehicle 105(2) may inform gNB 110(2) that vehicle 105(2) is searching for a platoon to join, e.g., by broadcasting a platoon discovery request to PM 135. Vehicle 105(2) may also discover the platoon by broadcasting platoon discovery requests to vehicle 105(1) (either directly or via gNB 110(2)) to join the platoon.

AMF 115 may authenticate vehicles 105(1) and 105(2) and download corresponding subscription profiles from UDR 120. PM 135 may obtain subscription information from UDR 120 via CF 125. PM 135 may also obtain dynamic location data of vehicles 105(1) and/or 105(2) via AMF 115 to determine that vehicles 105(1) and 105(2) are configured for platooning. The dynamic location data indicates a current or predicted location of vehicle 105(2). The dynamic location data may include an indication of a current physical location of vehicle 105(2), vehicle 105(2) handoff data between base stations (e.g., between gNBs 110(1) and 110(2)), an indication of an anticipated route of vehicle 105(2), a group identifier of vehicle 105(2), and/or an identification of one or more cells neighboring vehicle 105(2).

In one example, the indication of the current physical location of vehicle 105(2) may include location updates having the granularity of the location of gNB 110(2), Tracking Area Codes (TACs), Location Area Codes (LACs), and/or Global Positioning System (GPS) coordinates. The location updates may correspond to data for vehicle 105(2). Vehicle 105(2) may provide the current physical location to PM 135 via gNB 110(2), AMF 115, CF 125, and/or AS 130. PM 135 may determine whether, for a configurable duration of time, multiple vehicles (e.g., vehicles 105(1) and 105(2)) passed through the same location coordinates. If so, vehicles 105(1) and 105(2) are potentially suited for platoon group.

In another example, the handoff data may include network-captured handoff data of vehicle 105(2) for gNBs 110(1) and 110(2). This handoff data may be used to identify the moving pattern and path of vehicle 105(2). Based on identified pattern/path, PM 135 may determine the appropriate platoon for vehicle 105(2).

The indication of the anticipated route of vehicle 105(2) may include a current location, timestamp, and/or destination of vehicle 105(2). Vehicle 105(2) may also provide an indication of a route extending from the current location towards the destination. PM 135 may form a potential platoon group based on a common destination, for example. If vehicles 105(1) and 105(2) have common anticipated routes for a configured distance, PM 135 may consider putting vehicles 105(1) and 105(2) in the same platoon. PM 135 may use machine learning (ML) techniques with supervised learning based on historical data, or use mobility patterns in another approach.

The group identifier of vehicle 105(2) may indicate the platooning history of vehicle 105(2). Based on the group identifier, historic information may be stored about the route of vehicle 105(2). If PM 135 determines that vehicle 105(2) has the same group identifier as vehicle 105(1), vehicles 105(1) and 105(2) may be potential candidates for platooning.

The identification of one or more cells neighboring vehicle 105(2) may be based on Automatic Neighbor Relation (ANR). For example, gNB 110(2) may use different policies for instructing vehicle 105(2) to perform measurements, and when to report the measurements to gNB 110(2). When vehicle 105(2) discovers a new cell identifier, vehicle 105(2) reports the detected cell identifier to the serving cell of gNB 110(2). In addition, vehicle 105(2) may report the TAC and all Public Land Mobile Network (PLMN) IDs that have been detected. gNB 110(2) adds this neighbor relation to the Neighbor Relation Table (NRT).

PM 135 may also obtain platooning configuration information from UDR 120 which indicates whether vehicle 105(2) is available for platooning. The platooning configuration information may include platoon profile configuration information, platoon leader—specific configuration information, discontinuous reception and power saving functionality configuration information, platoon formation criteria, platoon destruction criteria, and vehicle removal criteria. Platoon profile configuration information may include an indication as to whether vehicles 105(1) and 105(2) are configured for automatic or non-automatic platooning. Platoon leader—specific configuration information may include selection criteria, Quality of Service (QoS) for the platoon leader (here, vehicle 105(1)), discontinuous reception and power saving functionality configurations for the vehicles 105(1) and 105(2), etc. Platoon formation criteria may include a minimum number of members required for platoon formation.

Based on the dynamic location data (and/or other received information), PM 135 may identify a platoon of vehicles that is optimal for vehicle 105(2) to join (e.g., the platoon led by vehicle 105(1)). In one example, PM 135 identifies a pre-existing platoon led by vehicle 105(1). PM 135 may use Machine Learning (ML) techniques to perform a predictive analysis to identify the platoon. If vehicle 105(2) is subscribed for automated platooning, PM 135 automatically identifies a platoon for vehicle 105(2) and provisions vehicle 105(2) with the platoon details. If vehicle 105(2) is subscribed for non-automated platooning, PM 135 identifies the platoon for vehicle 105(2) in response to a request from vehicle 105(2).

PM 135 may dynamically join vehicle 105(2) to the platoon. For example, PM 135 may provide platoon configuration/provisioning information to CF 125 via AS 130. CF 125 may authenticate and configure V2X communications on vehicles 105(1) and 105(2) in accordance with the received information. PM 135 (via AS 130) may thereby configure the platoon for vehicles 105(1) and 105(2) (e.g., cause vehicle 105(2) to join the pre-existing platoon led by vehicle 105(1)).

If vehicle 105(1) does not belong to a pre-existing platoon, PM 135 may dynamically create a new platoon that includes vehicles 105(1) and 105(2). As part of the creation, PM 135 may select a platoon leader (e.g., vehicle 105(1)) to communicate on behalf of the platoon with gNB 110(2) and enable authentication and provisioning of the platoon members (e.g., vehicle 105(2)).

At a subsequent point in time, PM 135 may obtain, from vehicle 105(2), updated dynamic location data for vehicle 105(2). Based on the updated dynamic location data, PM 135 may dynamically remove vehicle 105(2) from the platoon. For example, the updated dynamic location data may indicate that an anticipated route of vehicle 105(2) has changed, and as such PM 135 may determine that it would be inefficient for vehicle 105(2) to remain in the platoon.

In another example, other vehicles have dynamically joined the platoon in addition to vehicles 105(1) and 105(2), and PM 135 dynamically designates vehicle 105(2) as the current leader of the platoon in response to one or more of several possible triggers. One such trigger is vehicle 105(1) leaving the platoon. For example, vehicle 105(1) may have a different destination than vehicle 105(2) and the other vehicles in the platoon, and may therefore leave the platoon when routes to the respective destinations diverge.

Another trigger is vehicle 105(1) having poor network capabilities. For example, if PM 135 determines that certain network communication statistics for vehicle 105(1) fall below some threshold, vehicle 105(1) may be unable to adequately communicate with the 5G network on behalf of the other vehicles in the platoon.

Yet another trigger is PM 135 determining that the platoon is splitting into two or more new platoons. For example, vehicle 105(1) and a first subset of the other vehicles in the platoon have a different destination than vehicle 105(2) and the second subset of the other vehicles in the platoon. As such, vehicle 105(1) and the first subset may split from vehicle 105(2) and the second subset when routes to the respective destinations diverge. In this case, PM 135 may dynamically designate vehicle 105(1) as a current leader of the new platoon comprising vehicle 105(1) and the first subset, and may further dynamically designate vehicle 105(2) as a current leader of the new platoon comprising vehicle 105(2) and the second subset.

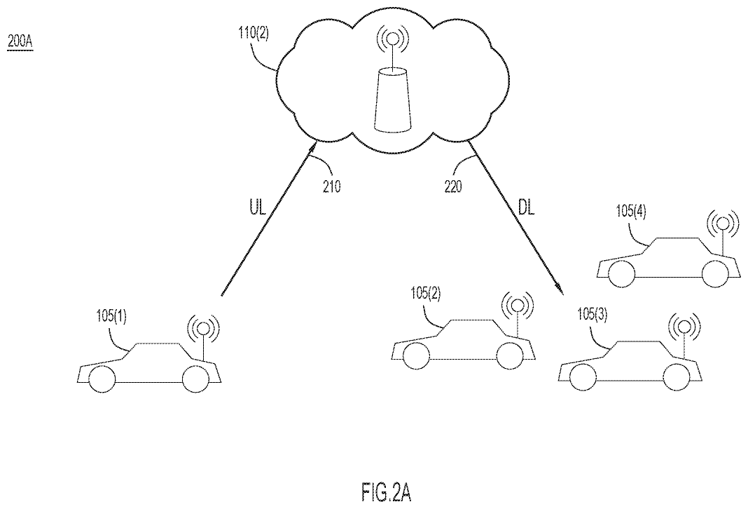

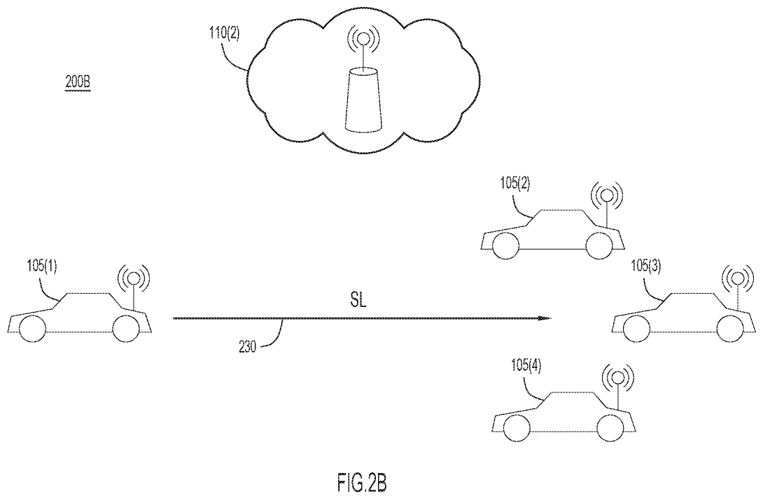

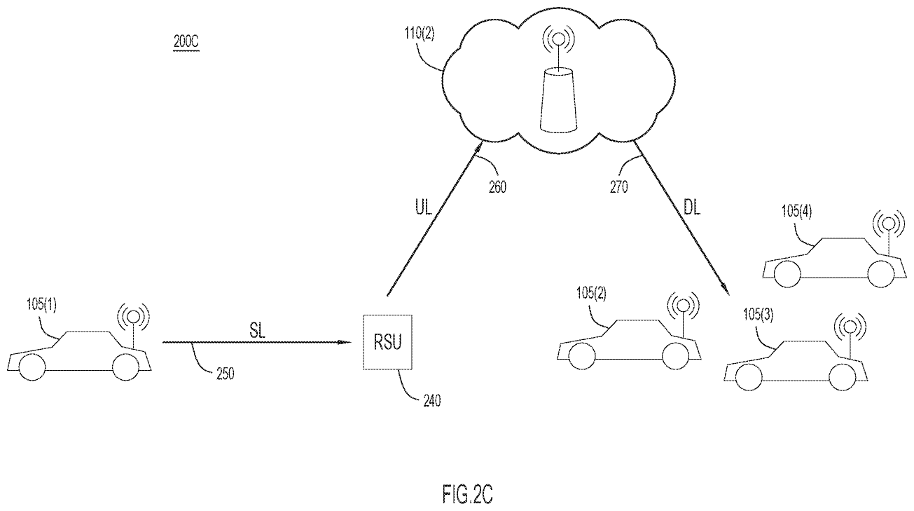

FIGS. 2A-2C illustrate portions 200A-200C of system 100 relating to vehicular communication. Portion 200A includes vehicles 105(1)-105(4) and gNB 110(2). Vehicles 105(1)-105(4) are members of the same platoon, of which vehicle 105(1) is the platoon leader. As platoon leader, vehicle 105(1) may provide communications to vehicles 105(2)-105(4). The communications may include directions/route information, commands to cause vehicles 105(2)-105(4) to maintain a certain distance from each other, etc. Vehicle 105(1) may provide the communications periodically or on-demand.

Vehicle 105(1) may communicate with vehicles 105(2)-105(4) via uplink (UL) 210 and downlink (DL) 220. Uplink 210 and downlink 220 may comprise an air interface supported by MBMS. Vehicle 105(1) may provide a communication via uplink 210 to gNB 110(2), which may relay the communication to one or more of vehicles 105(2)-105(4) via downlink 220. Thus, portion 200A illustrates network-based vehicular communication.

Portion 200B illustrates direct vehicular communication between vehicle 105(1) and vehicles 105(2)-105(4) via side link 230. As shown, side link (SL) 230 is directly between vehicle 105(1) and vehicles 105(2)-105(4), bypassing gNB 110(2) entirely. Side link 230 may be a PC5 interface, for example.

Portion 200C illustrates another network-based vehicular communication via Road Side Unit (RSU) 240. RSU 240 may be a stationary infrastructure device acting as a UE. For example, RSU 240 may be integrated into a traffic signal. RSU 240 may also be co-located with gNB 110(2). If RSU 240 is a stationary UE, RSU 240 may communicate with AS 130 (in the core network) and distribute messages to vehicles 105(2)-105(4). RSU 240 may provide, to vehicles 105(1)-105(4), road weather conditions, traffic conditions, etc. In this example, vehicle 105(1) communicates with RSU 240 via side link 250. RSU 240 may provide a communication from vehicle 105(1) via uplink 260 to gNB 110(2), which may relay the communication to one or more of vehicles 105(2)-105(4) via downlink 270. In one example, the location updates described above may correspond to data for RSU 240 in addition to or instead of vehicle 105(2).

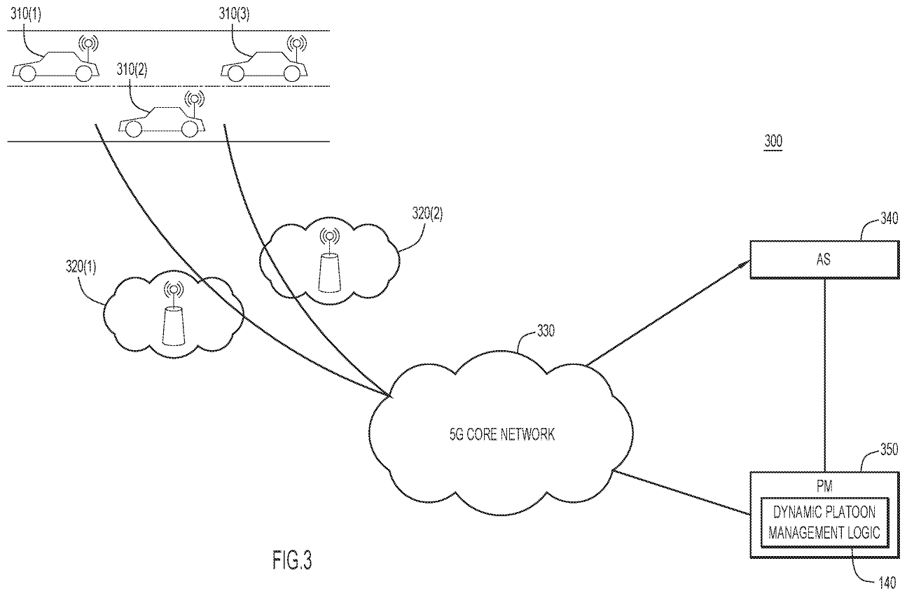

FIG. 3 illustrates an example system 300 configured for a first use case for dynamic platoon management. System 300 includes vehicles 310(1)-310(3), gNBs 320(1) and 320(2), 5G core network 330, AS 340, and PM 350, which includes dynamic platoon management logic 140. In this example, PM 350 dynamically forms a platoon based on information provided by vehicles 310(1)-310(3) when in network coverage. PM 350 may use multiple criteria as described above to determine the potential platoon group(s).

Vehicles 310(1)-310(3) are all traveling in the same direction and have connectivity to 5G core network 330. The destination of vehicle 310(1) may be city A, the destination of vehicle 310(2) may be city C via city B, and the destination of vehicle 310(3) may be City B via City A. Vehicles 310(1)-310(3) each advertise a request to join a platoon. The dynamic location data of vehicles 310(1)-310(3), including the destination information, is provided to PM 350. Based on the dynamic location data, PM 350 forms a dynamic platoon and provisions vehicles 310(1)-310(3) with platoon characteristics. Vehicles 310(1)-310(3) then travel in platoon formation towards city A.

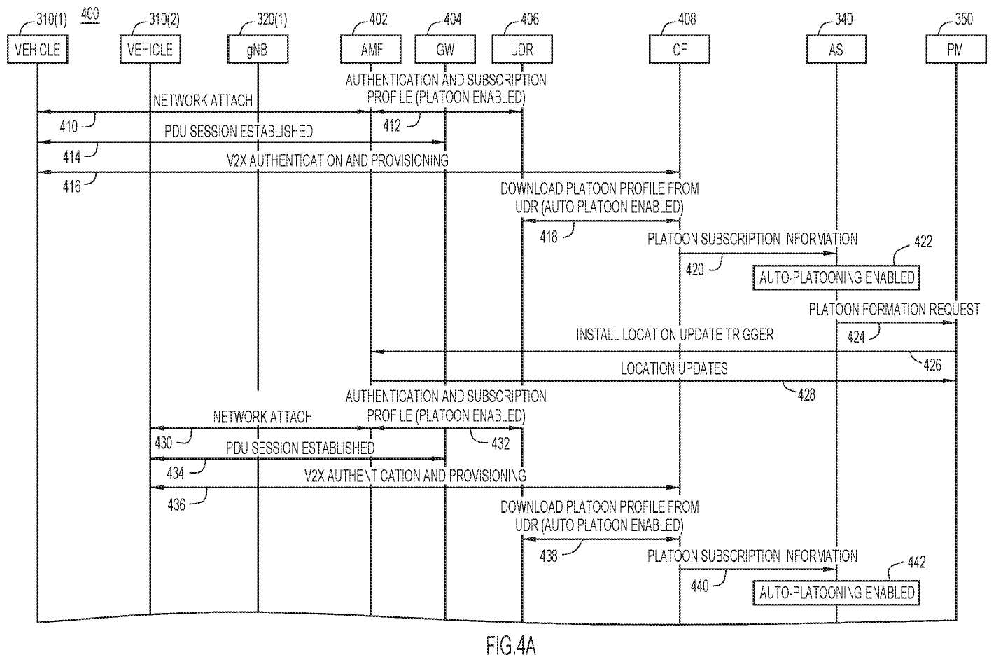

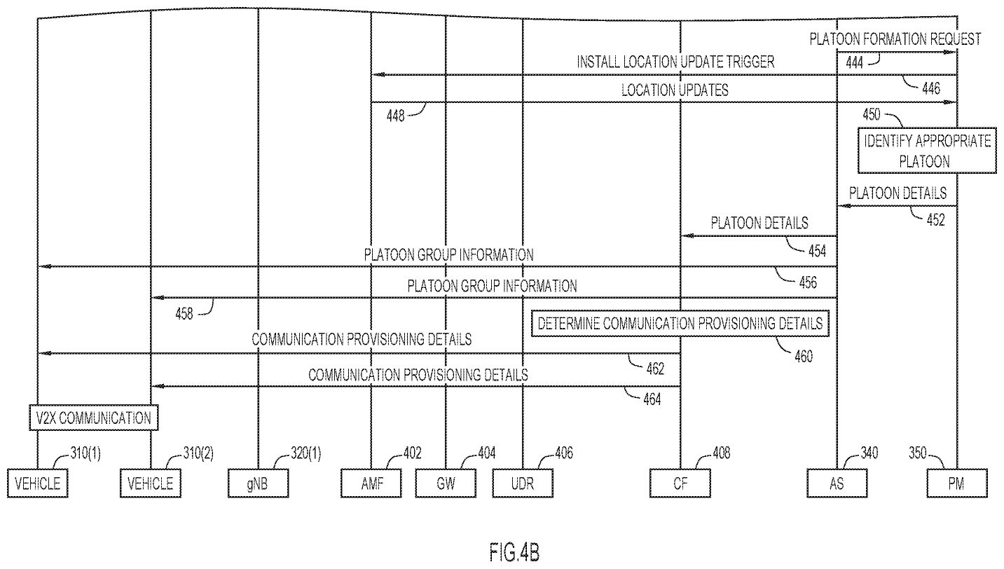

FIGS. 4A and 4B together provide an example call flow diagram 400 illustrating operations for the first use case for dynamic platoon management. Reference is also made to FIG. 3 for the purposes of describing FIG. 4. Operations in call flow diagram 400 are performed by vehicles 310(1) and 310(2), gNB 320(1), AMF 402, GW 404, UDR 406, CF 408, AS 340, and PM 350. AMF 402, GW 404, UDR 406, and CF 408 may be entities in core network 330. GW 404 may also be referred to as a Session Management Function (SMF)/User Plane Function (UPF).

At 410, vehicle 310(1) attaches to the network (e.g., via a Packet Data Network (PDN) connection). At 412, AMF 402 authenticates vehicle 310(1) and downloads the subscription profile from UDR 406 to determine that vehicle 310(1) is configured for automated platooning. At 414, vehicle 310(1) establishes a Packet Data Unit (PDU) session with GW 404. At 416, vehicle 310(1) connects to CF 408 via a V3 interface and becomes authorized and provisioned. If vehicle 310(1) was configured in non-automated mode, CF 408 would interact with PM 350 to dynamically form a platoon in response to a request from vehicle 310(1). However, because vehicle 310(1) is configured in automated mode in this example, CF 408 automatically interacts with PM 350 to dynamically form a platoon.

Specifically, at 418, CF 408 downloads the platoon profile of vehicle 310(1) from UDR 406. At 420, CF 408 provides platoon subscription information for vehicle 310(1) to AS 340. At 422, AS 340 determines that auto-platooning is enabled for vehicle 310(1). At 424, PM 350 obtains a platoon formation request from AS 340. At 426, PM 350 installs a location update trigger on AMF 402 for vehicle 310(1). At 428, PM 350 obtains location updates for vehicle 310(1) from AMF 402.

At 430, vehicle 310(2) attaches to the network. At 432, AMF 402 authenticates vehicle 310(2) and downloads the subscription profile from UDR 406 to determine that vehicle 310(2) is configured for automated platooning. At 434, vehicle 310(2) establishes a PDU session with GW 404. At 436, vehicle 310(2) connects to CF 408 via a V3 interface and becomes authorized and provisioned.

At 438, CF 408 downloads the platoon profile of vehicle 310(2) from UDR 406. At 440, CF 408 provides platoon subscription information for vehicle 310(2) to AS 340. At 442, AS 340 determines that auto-platooning is enabled for vehicle 310(2). At 444, PM 350 obtains a platoon formation request from AS 340. At 446, PM 350 installs a location update trigger on AMF 402 for vehicle 310(2). At 448, PM 350 obtains location updates for vehicle 310(2) from AMF 402.

At 450, PM 350 identifies the appropriate platoon for vehicles 310(1) and 310(2). PM 350 may determine the platoon for vehicles 310(1) and 310(2) based on certain criteria such as current location, direction, destination, etc. PM 350 may also consider handover patterns, location updates, and UE group information. Based on this criteria, PM 350 may identify an existing platoon suitable for vehicles 310(1) and 310(2), or create a new platoon for vehicles 310(1) and 310(2).

At 452, PM 350 informs AS 340 about the platoon details. For example, PM 350 may identify a specific platoon (e.g., “group xyz123”). At 454, AS 340 provides the platoon details (e.g., “group xyz123”) to CF 408. At 456, AS 340 configures (informs) vehicle 310(1) with (of) the platoon group information. At 458, AS 340 configures (informs) vehicle 310(2) with (of) the platoon group information.

At 460, CF 408 determines communication provisioning details for vehicles 310(1) and 310(2). The communication provisioning details may include PC5 interface and other parameters to enable vehicles 310(1) and 310(2) to communicate with each other. If vehicles 310(1) and/or 310(2) are in a Visited PLMN (VPLMN), CF 408 may communicate with another CF in the VPLMN (e.g., via a V6 interface) to obtain the authorized PC5 and other parameters. At 462, CF 408 provides the communication provisioning details to vehicle 310(1). At 464, CF 408 provides the communication provisioning details to vehicle 310(2). After a platoon group is formed and vehicles 310(1) and 310(2) are configured, vehicles 310(1) and 310(2) may start communicating in the platoon.

In one example, platoon leader selection may be performed. A platoon leader may be designated by the network (e.g., PM 350) based on configuration and criteria in AS 340 and the capabilities of vehicles 310(1) and 310(2). Alternatively, vehicles 310(1) and 310(2) (and any other vehicles in the platoon) may select a platoon leader based on voting or round robin. The platoon leader may perform functions including authentication/provisioning of other members, communicating with the network on behalf of the platoon, providing location updates/handoff for the entire platoon, etc. Once a platoon leader is designated, AMF 402 may enhance the QoS capabilities of the platoon leader.

CF 408 may inform AMF 402 about the platoon group details (members and leaders) which may be stored in UDR 406. This may assist AMF 402 in performing location updates and handoffs for all the platoon members based on information received from the platoon leader. The network may also perform periodic authentication/authorization of the platoon leader, and may provide authentication vectors to the platoon leader to perform periodic authentication of other platoon members. After a member leaves the platoon, PM 350 may indicate to AS 340 to add another member in the platoon depending upon the size of platoon. Furthermore, the platoon may be destroyed/terminated by the network (e.g., PM 350) or by members of platoon.

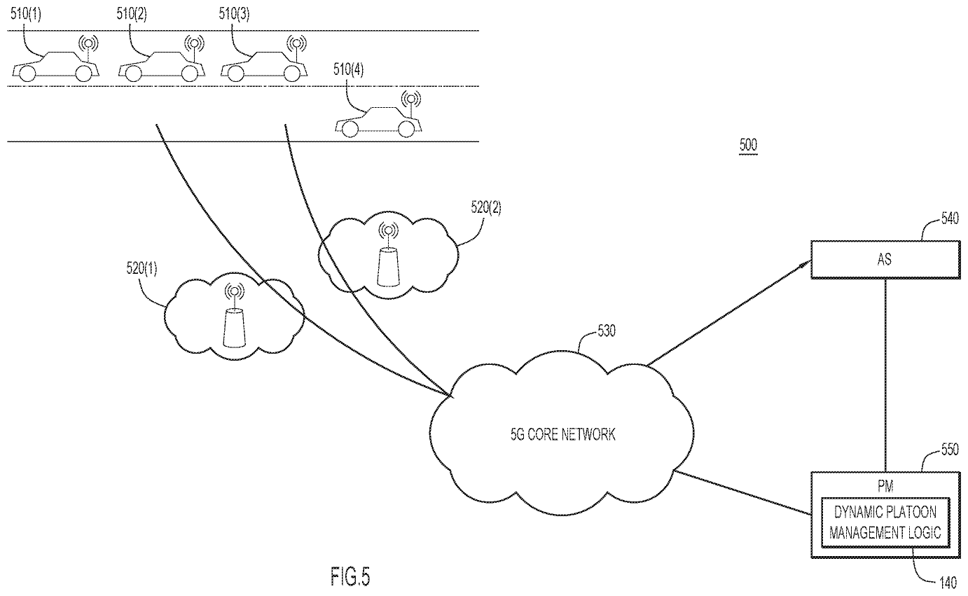

FIG. 5 illustrates an example system 500 configured for a second use case for dynamic platoon management. System 500 includes vehicles 510(1)-510(4), gNBs 520(1) and 520(2), 5G core network 530, AS 540, and PM 550, which includes dynamic platoon management logic 140. In one example, vehicles 510(1)-510(3) are traveling in a pre-existing platoon toward city A. Vehicle 510(1) may be the platoon leader. The destination of vehicle 510(4) is city B via city A. Vehicle 510(4) provides dynamic location data, including the destination information, and requests to be added to a platoon. Based on the dynamic location data, PM 350 assigns vehicle 510(4) to the platoon comprising vehicles 510(1)-510(3). PM 350 configures vehicle 510(4) with platoon details via 5G core network 330.

In another example, vehicles 510(1)-510(4) are all members of the same platoon, and PM 350 removes vehicle 510(4) from the platoon. This may be in response to a request from vehicle 510(4) or when the route of vehicle 510(4) (destined for city B via city A) diverges from that of the platoon (destined for city A).

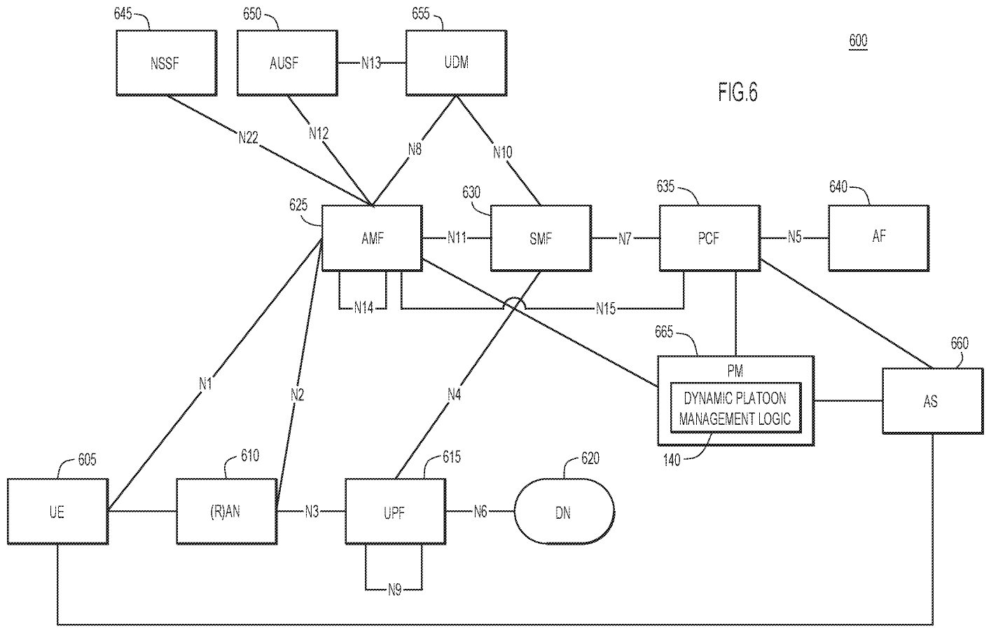

FIG. 6 illustrates an example 5G system 600 (e.g., New Radio (NR) cellular network) configured for dynamic platoon management. System 600 includes UE 605, which may be a vehicle, RSU, etc. that includes a V2X application. System 600 also includes (Radio) Access Network (R)AN 610, UPF 615, and Data Network (DN) 620 (e.g., operator services, Internet access, third-party services, etc.). (R)AN 610 is configured to communicate with UPF 615 via an N3 interface, and UPF 615 is configured to communicate with DN 620 via an N6 interface.

System 600 further includes Access and Mobility Management Function (AMF) 625, SMF 630, Policy Control Function (PCF) 635, and Application Function (AF) 640. AMF is configured to communicate with UE 605 via an N1 interface, with (R)AN 610 via an N2 interface, SMF 630 via an N11 interface, and PCF 635 via an N15 interface. SMF 630 is configured to communicate with UPF 615 via an N4 interface and PCF 635 via an N7 interface. PCF 635 is configured to communicate with AF 640 via an N5 interface.

System 600 further includes Network Slice Selection Function (NSSF) 645, Authentication Server Function (AUSF) 650, and Unified Data Management (UDM) 655. NSSF 645 is configured to communicate with AMF 625 via an N22 interface. AUSF 650 is configured to communicate with AMF 625 via an N12 interface and UDM 655 via an N13 interface. UDM 655 is configured to communicate with AMF 625 via an N8 interface and SMF 630 via an N10 interface.

System 600 also includes AS 660 and PM 665. AS 660 is configured to communicate with PCF 635, UE 605, and PM 665. PM 665 is configured to communicate with AMF 625 and PCF 635. As shown, PM 665 includes dynamic platoon management logic 140. Using the aforementioned 5G interfaces and dynamic platoon management techniques, PM 665 may dynamically manage one or more platoons. For example, if UE 605 join the network at or near the same time as one or more other UEs, PM 665 may use ML algorithms/heuristics to determine whether the UEs should be in the same platoon. Thus, techniques described herein may be implemented in a 5G network.

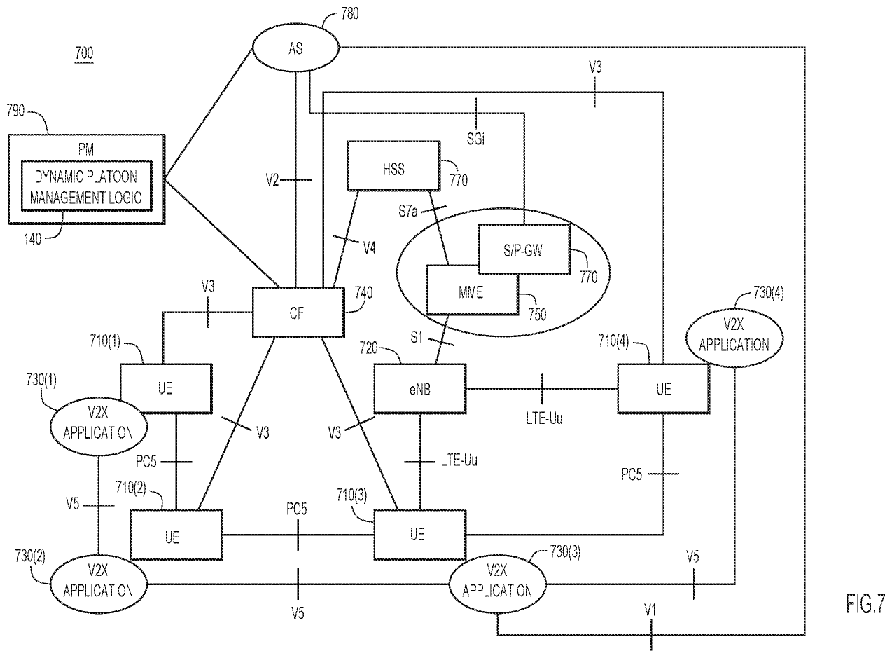

FIG. 7 illustrates an example 4G system 700 (e.g., Long-Term Evolution (LTE) cellular network) configured for dynamic platoon management. System 700 includes UEs 710(1)-710(4) and eNodeB (eNB) 720. UE 710(1) may be a cell phone (e.g., used by a pedestrian). UE 710(2) and 710(3) may be vehicles. UE 710(4) may be a RSU. UEs 710(1)-710(4) each include a respective V2X applications 730(1)-730(4). In this example, UEs 710(1)-710(4) are configured to communicate with each other via PC5 interfaces, and V2X applications 730(1)-730(4) are configured to communicate with each other via V5 interfaces.

System 700 also includes CF 740, Mobility Management Entity (MME) 750, Serving and PDN Gateways (S/P-GW) 760, Home Subscriber Server (HSS) 770, AS 780, and PM 790, which includes dynamic platoon management logic 140. MME 750 is responsible for authentication of UEs 710(1)-710(4) and manages handover. S/P-GW 760 provide both control plane and data plane functionalities (e.g., routing and forwarding data packets, providing Internet Protocol (IP) addresses for UEs 710(1)-710(4), providing connectivity to the PDN, etc.). HSS 770 is a repository that includes subscriber information.

UEs 710(1)-710(4) are configured to communicate with CF 740 via V3 interfaces. V2X application 730(3) is configured to communicate with AS 780 via a V1 interface. UEs 710(3) and 710(4) are configured to communicate with eNB 720 via LTE-Uu interfaces. eNB 720 is configured to communicate with MME 750 and/or S/P-GW 760 via an S1 interface. MME 750 is configured to communicate with HSS 770 via an S6a interface. S/P-GW 760 is configured to communicate with AS 780 via an SGi interface. CF 740 is configured to communicate with HSS 770 via a V4 interface, and with AS 780 via a V2 interface. CF 740 and AS 780 are configured to communicate with PM 790.

Using the aforementioned 4G interfaces and dynamic platoon management techniques, PM 790 may dynamically manage one or more platoons. For example, if UEs 710(2) and 710(3) join the network at or near the same time, PM 790 may use ML algorithms/heuristics to determine whether UEs 710(2) and 710(3) should be in the same platoon. Thus, techniques described herein may be implemented in a 4G network.

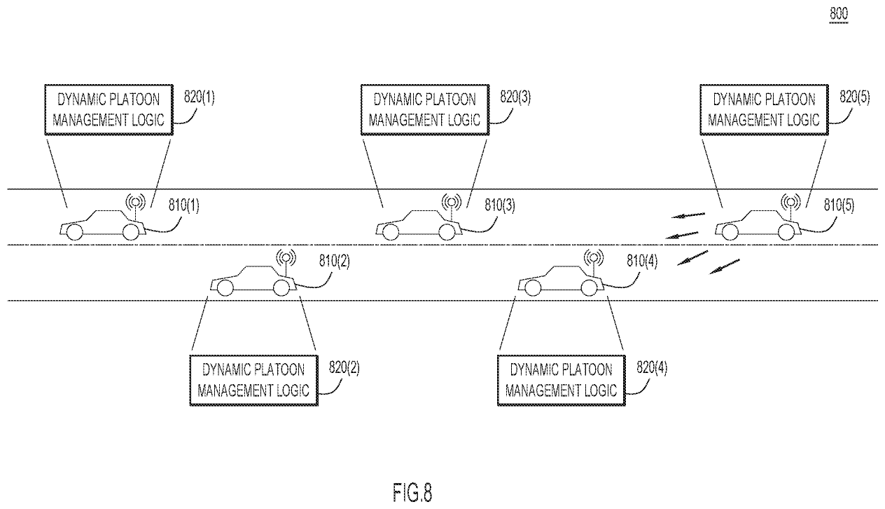

FIG. 8 illustrates an example system 800 configured for a third use case for dynamic platoon management. System 800 includes vehicles 810(1)-810(5), each of which respectively includes dynamic platoon management logic 820(1)-820(5). As shown in FIG. 8, techniques described herein may be also implemented by vehicles 810(1)-810(5) without a PM or other network nodes. This may be useful for vehicles that are not in network coverage but would nonetheless benefit from dynamically forming/joining a platoon. In this example, the destination of vehicle 810(1) is city A, the destination of vehicles 810(2)-810(4) is city B via city A, and the destination of vehicle 810(5) is city C via city B. As such, vehicles 810(1)-810(5) are traveling in the same direction.

Vehicles 810(2)-810(4) may already be members of a pre-existing platoon. Vehicles 810(1) and 810(5) may discover the platoon by providing platoon discovery requests/User Service Descriptions (USDs). Instead of proceeding to a core network, the platoon discovery requests proceed via PC5 interfaces to vehicles 810(2)-810(4). Vehicles 810(2)-810(4) may authenticate vehicles 810(1) and 810(5) using a private mechanism and permit vehicles 810(1) and 810(5) to dynamically join the platoon. In another example, vehicles 810(1)-810(5) may initially be traveling independent of each other (i.e., 810(2)-810(4) are not in a pre-existing platoon) and dynamically create a new platoon that includes each of vehicles 810(1)-810(5). Vehicles 810(1)-810(5) may dynamically select a platoon leader, leave the platoon, split into two smaller platoons, etc.

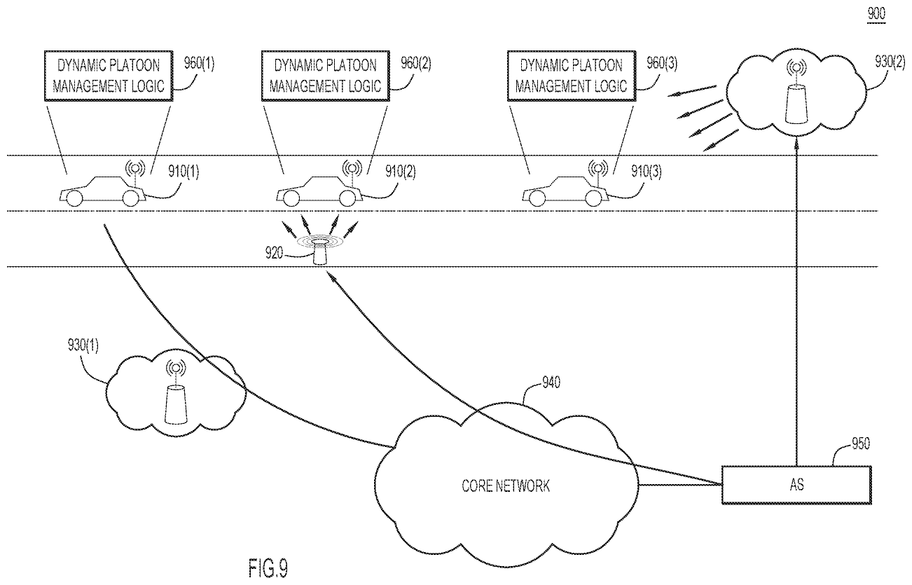

FIG. 9 illustrates an example system 900 configured for a fourth use case for dynamic platoon management. System 900 includes vehicles 910(1)-910(3), RSU 920, eNBs 930(1) and 930(2), core network 940, and AS 950. Vehicles 910(1)-910(3) respectively include dynamic platoon management logic 960(1)-960(3). As shown in FIG. 9, techniques described herein may be also implemented by vehicles 910(1)-910(3) with assistance from core network 940. Core network 940 may be a 4G or 5G core network.

In this example, the destination of vehicle 910(1) is city A, the destination of vehicle 910(2) is city B via city A, and the destination of vehicle 910(3) is city C via city B. As such, vehicles 910(1)-910(3) are traveling in the same direction. Vehicle 910(1) may be configured with standardized USD details, and may communicate to core network 940 an indication that vehicle 910(1) is ready to join/form a platoon. For example, vehicle 910(1) may provide AS 950 (via RSU 920) platooning requirements along with dynamic location data of vehicle 910(1).

To facilitate platoon formation, AS 950 may in turn broadcast the platoon formation details to nearby locations, for example through RSUs (e.g., RSU 920) and/or eNBs (e.g., eNBs 930(1) and/or 930(2)). For example, RSU 920 and eNB 930(2) may advertise the availability of potential platoon group “abc.” RSU 920 may use a PC5 interface for communications. Core network 940 may broadcast messages using MBMS.

Vehicles 910(2) and 910(3) may listen and broadcast via MBMS/PC5 interfaces on a pre-configured channel from RSU 920 and connect to vehicle 910(1). Vehicles 910(1)-910(3) may thus dynamically form a platoon. Alternatively, if vehicle 910(1) is already part of a platoon, vehicles 910(2) and 910(3) may join the platoon. Once vehicles 910(1)-910(3) belong to the same platoon, vehicles 910(1)-910(3) may select a platoon leader. In this example, vehicles 910(1)-910(3) select vehicle 910(1) as the platoon leader because vehicle 910(1) has connectivity with core network 940.

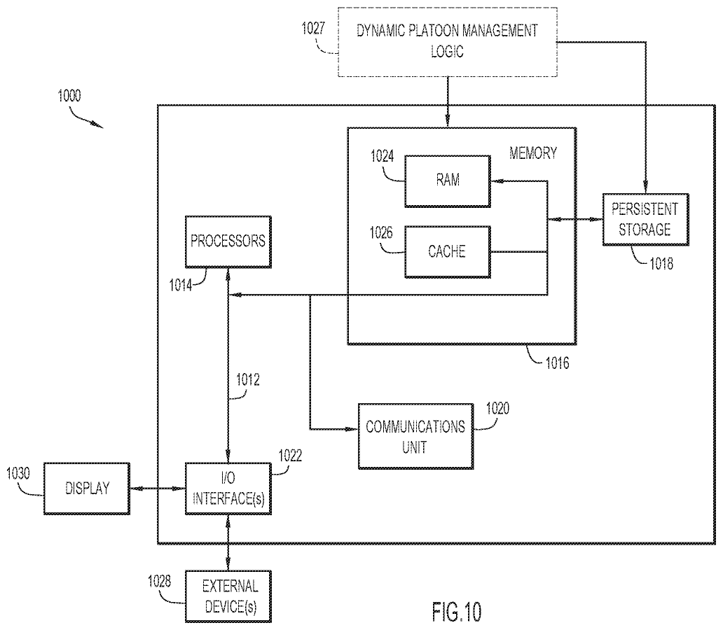

FIG. 10 illustrates a hardware block diagram of a computing device 1000 that may perform the functions of any of the servers or computing or control entities referred to herein in connection with dynamic platoon management. Device 1000 may comprise a PM or one or more vehicles, for example. It should be appreciated that FIG. 10 provides only an illustration of one embodiment and does not imply any limitations with regard to the environments in which different embodiments may be implemented. Many modifications to the depicted environment may be made.

As depicted, the device 1000 includes a bus 1012, which provides communications between computer processor(s) 1014, memory 1016, persistent storage 1018, communications unit 1020, and input/output (I/O) interface(s) 1022. Bus 1012 can be implemented with any architecture designed for passing data and/or control information between processors (such as microprocessors, communications and network processors, etc.), system memory, peripheral devices, and any other hardware components within a system. For example, bus 1012 can be implemented with one or more buses.

Memory 1016 and persistent storage 1018 are computer readable storage media. In the depicted embodiment, memory 1016 includes random access memory (RAM) 1024 and cache memory 1026. In general, memory 1016 can include any suitable volatile or non-volatile computer readable storage media. Instructions for dynamic platoon management logic 1027 may be stored in memory 1016 or persistent storage 1018 for execution by processor(s) 1014.

One or more programs may be stored in persistent storage 1018 for execution by one or more of the respective computer processors 1014 via one or more memories of memory 1016. The persistent storage 1018 may be a magnetic hard disk drive, a solid state hard drive, a semiconductor storage device, read-only memory (ROM), erasable programmable read-only memory (EPROM), flash memory, or any other computer readable storage media that is capable of storing program instructions or digital information.

The media used by persistent storage 1018 may also be removable. For example, a removable hard drive may be used for persistent storage 1018. Other examples include optical and magnetic disks, thumb drives, and smart cards that are inserted into a drive for transfer onto another computer readable storage medium that is also part of persistent storage 1018.

Communications unit 1020, in these examples, provides for communications with other data processing systems or devices. In these examples, communications unit 1020 includes one or more network interface cards. Communications unit 1020 may provide communications through the use of either or both physical and wireless communications links.

I/O interface(s) 1022 allows for input and output of data with other devices that may be connected to computer device 1000. For example, I/O interface 1022 may provide a connection to external devices 1028 such as a keyboard, keypad, a touch screen, and/or some other suitable input device. External devices 1028 can also include portable computer readable storage media such as database systems, thumb drives, portable optical or magnetic disks, and memory cards.

Software and data used to practice embodiments can be stored on such portable computer readable storage media and can be loaded onto persistent storage 1018 via I/O interface(s) 1022. I/O interface(s) 1022 may also connect to a display 1030. Display 1030 provides a mechanism to display data to a user and may be, for example, a computer monitor.

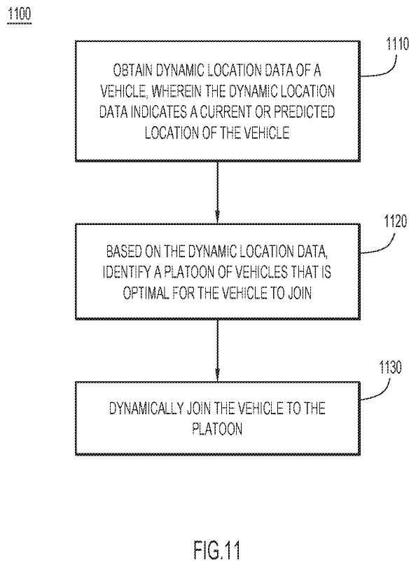

FIG. 11 is a flowchart of a method 1100 for dynamic platoon management. Method 1100 may be performed by a PM or one or more UEs (e.g., vehicles). At 1110, dynamic location data of a vehicle is obtained. The dynamic location data indicates a current or predicted location of the vehicle. At 1120, based on the dynamic location data, a platoon of vehicles that is optimal for the vehicle to join is identified. At 1130, the vehicle is dynamically joined to the platoon.

Techniques described herein enable dynamic platoon formation for a set of UEs when the UEs are in coverage or out of coverage. For example, a vehicle may be added or removed from a platoon group. In one specific example, a UDR may include a platoon-specific configuration. Furthermore, a PM may include logic to determine/identify the appropriate platoon group based on certain criteria.

As such, dynamic, automated creation of platoons may be enabled based on UE location, path, and other considerations. Dynamic addition and deletion of platoon members may also be enabled. These techniques eliminate the need for static platoon configuration. A PM may assist in the determination of a dynamic platoon based on network configuration data and other historical data. In addition, authorization/authentication of members of the platoon may be optimized with reduced radio resource usage. These techniques also enable optimized handoff for all platoon members with reduced radio and Non-Access Stratum (NAS) signaling.

The programs described herein are identified based upon the application for which they are implemented in a specific embodiment. However, it should be appreciated that any particular program nomenclature herein is used merely for convenience, and thus the embodiments should not be limited to use solely in any specific application identified and/or implied by such nomenclature.

Data relating to operations described herein may be stored within any conventional or other data structures (e.g., files, arrays, lists, stacks, queues, records, etc.) and may be stored in any desired storage unit (e.g., database, data or other repositories, queue, etc.). The data transmitted between entities may include any desired format and arrangement, and may include any quantity of any types of fields of any size to store the data. The definition and data model for any datasets may indicate the overall structure in any desired fashion (e.g., computer-related languages, graphical representation, listing, etc.).

The present embodiments may employ any number of any type of user interface (e.g., Graphical User Interface (GUI), command-line, prompt, etc.) for obtaining or providing information (e.g., data relating to scraping network sites), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The environment of the present embodiments may include any number of computer or other processing systems (e.g., client or end-user systems, server systems, etc.) and databases or other repositories arranged in any desired fashion, where the present embodiments may be applied to any desired type of computing environment (e.g., cloud computing, client-server, network computing, mainframe, stand-alone systems, etc.). The computer or other processing systems employed by the present embodiments may be implemented by any number of any personal or other type of computer or processing system (e.g., desktop, laptop, PDA, mobile devices, etc.), and may include any commercially available operating system and any combination of commercially available and custom software (e.g., machine learning software, etc.). These systems may include any types of monitors and input devices (e.g., keyboard, mouse, voice recognition, etc.) to enter and/or view information.

It is to be understood that the software of the present embodiments may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present embodiments may be distributed in any manner among the various end-user/client and server systems, and/or any other intermediary processing devices. The software and/or algorithms described above and illustrated in the flow charts may be modified in any manner that accomplishes the functions described herein. In addition, the functions in the flow charts or description may be performed in any order that accomplishes a desired operation.

The software of the present embodiments may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, VPN, etc.). The computer or other processing systems of the present embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., data relating to contact center interaction routing). The database system may be implemented by any number of any conventional or other databases, data stores or storage structures (e.g., files, databases, data structures, data or other repositories, etc.) to store information (e.g., data relating to contact center interaction routing). The database system may be included within or coupled to the server and/or client systems. The database systems and/or storage structures may be remote from or local to the computer or other processing systems, and may store any desired data (e.g., data relating to contact center interaction routing).

The present embodiments may employ any number of any type of user interface (e.g., Graphical User Interface (GUI), command-line, prompt, etc.) for obtaining or providing information (e.g., data relating to providing enhanced delivery options), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The embodiments presented may be in various forms, such as a system, a method, and/or a computer program product at any possible technical detail level of integration. The computer program product may include a computer readable storage medium (or media) having computer readable program instructions thereon for causing a processor to carry out aspects of presented herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiments may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects presented herein.

Aspects of the present embodiments are described herein with reference to flowchart illustrations and/or block diagrams of methods, apparatus (systems), and computer program products according to the embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In one form, a method is provided. The method comprises: obtaining dynamic location data of a vehicle, wherein the dynamic location data indicates a current or predicted location of the vehicle; based on the dynamic location data, identifying a platoon of vehicles that is optimal for the vehicle to join; and dynamically joining the vehicle to the platoon.

In one example, obtaining the dynamic location data includes obtaining an indication of a current physical location of the vehicle. In another example, obtaining the dynamic location data includes obtaining vehicle handoff data between base stations. In yet another example, obtaining the dynamic location data includes obtaining an indication of an anticipated route of the vehicle. In yet another example, obtaining the dynamic location data includes obtaining a group identifier of the vehicle. In yet another example, obtaining the dynamic location data includes obtaining an identification of one or more cells neighboring the vehicle.

In one example, the method further comprises: dynamically designating the vehicle as a current leader of the platoon in response to a previous leader of the platoon leaving the platoon. In another example, the method further comprises: dynamically designating the vehicle as a current leader of the platoon in response to determining that a previous leader of the platoon has poor network capabilities. In yet another example, the method further comprises: determining that the platoon is splitting into two or more new platoons of vehicles; and in response to determining that the platoon is splitting into the two or more new platoons of vehicles, dynamically designating the vehicle as a current leader of one of the two or more new platoons of vehicles.

In one example, dynamically joining the vehicle to the platoon includes: dynamically creating a new platoon of vehicles that includes the vehicle.

In one example, the method further comprises: obtaining, from the vehicle, updated dynamic location data for the vehicle; and based on the updated dynamic location data, dynamically removing the vehicle from the platoon.

In another form, an apparatus is provided. The apparatus comprises: one or more network interfaces configured to provide and/or obtain network communications; and one or more processors coupled to the one or more network interfaces, wherein the one or more processors are configured to: obtain dynamic location data of a vehicle, wherein the dynamic location data indicates a current or predicted location of the vehicle; based on the dynamic location data, identify a platoon of vehicles that is optimal for the vehicle to join; and dynamically join the vehicle to the platoon.

In another form, one or more non-transitory computer readable storage media are provided. The one or more non-transitory computer readable storage media are encoded with instructions that, when executed by a processor, cause the processor to: obtain dynamic location data of a vehicle, wherein the dynamic location data indicates a current or predicted location of the vehicle; based on the dynamic location data, identify a platoon of vehicles that is optimal for the vehicle to join; and dynamically join the vehicle to the platoon.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
obtaining dynamic location data of a vehicle, wherein the dynamic location data indicates a current or predicted location of the vehicle;
based on the dynamic location data, identifying a platoon of vehicles that is optimal for the vehicle to join; and
dynamically joining the vehicle to the platoon.

2. The method of claim 1, wherein obtaining the dynamic location data includes obtaining an indication of a current physical location of the vehicle.

3. The method of claim 1, wherein obtaining the dynamic location data includes obtaining vehicle handoff data between base stations.

4. The method of claim 1, wherein obtaining the dynamic location data includes obtaining an indication of an anticipated route of the vehicle.

5. The method of claim 1, wherein obtaining the dynamic location data includes obtaining a group identifier of the vehicle.

6. The method of claim 1, wherein obtaining the dynamic location data includes obtaining an identification of one or more cells neighboring the vehicle.

7. The method of claim 1, further comprising:
dynamically designating the vehicle as a current leader of the platoon in response to a previous leader of the platoon leaving the platoon.

8. The method of claim 1, further comprising:
dynamically designating the vehicle as a current leader of the platoon in response to determining that a previous leader of the platoon has poor network capabilities.

9. The method of claim 1, further comprising:
determining that the platoon is splitting into two or more new platoons of vehicles; and
in response to determining that the platoon is splitting into the two or more new platoons of vehicles, dynamically designating the vehicle as a current leader of one of the two or more new platoons of vehicles.

10. The method of claim 1, wherein dynamically joining the vehicle to the platoon includes:
dynamically creating a new platoon of vehicles that includes the vehicle.

11. The method of claim 1, further comprising:
obtaining, from the vehicle, updated dynamic location data for the vehicle; and
based on the updated dynamic location data, dynamically removing the vehicle from the platoon.

12. An apparatus comprising:
one or more network interfaces configured to provide and/or obtain network communications; and
one or more processors coupled to the one or more network interfaces, wherein the one or more processors are configured to:
obtain dynamic location data of a vehicle, wherein the dynamic location data indicates a current or predicted location of the vehicle;
based on the dynamic location data, identify a platoon of vehicles that is optimal for the vehicle to join; and
dynamically join the vehicle to the platoon.

13. The apparatus of claim 12, wherein the dynamic location data includes one or more of:
an indication of a current physical location of the vehicle;
vehicle handoff data between base stations;
an indication of an anticipated route of the vehicle;
a group identifier of the vehicle; and
an identification of one or more cells neighboring the vehicle.

14. The apparatus of claim 12, wherein one or more processors are further configured to:
dynamically designate the vehicle as a current leader of the platoon in response to one or more of:
a previous leader of the platoon leaving the platoon; and
determining that a previous leader of the platoon has poor network capabilities.

15. The apparatus of claim 12, wherein one or more processors are further configured to:
determine that the platoon is splitting into two or more new platoons of vehicles; and
in response to determining that the platoon is splitting into the two or more new platoons of vehicles, dynamically designate the vehicle as a current leader of one of the two or more new platoons of vehicles.

16. The apparatus of claim 12, wherein the one or more processors are further configured to:
dynamically create a new platoon of vehicles that includes the vehicle.

17. The apparatus of claim 12, wherein the one or more processors are further configured to:
obtain, from the vehicle, updated dynamic location data for the vehicle; and
based on the updated dynamic location data, dynamically remove the vehicle from the platoon.

18. One or more non-transitory computer readable storage media encoded with instructions that, when executed by a processor, cause the processor to:
obtain dynamic location data of a vehicle, wherein the dynamic location data indicates a current or predicted location of the vehicle;
based on the dynamic location data, identify a platoon of vehicles that is optimal for the vehicle to join; and
dynamically join the vehicle to the platoon.

19. The one or more non-transitory computer readable storage media of claim 18, wherein the dynamic location data includes one or more of:
an indication of a current physical location of the vehicle;
vehicle handoff data between base stations;
an indication of an anticipated route of the vehicle;
a group identifier of the vehicle; and
an identification of one or more cells neighboring the vehicle.

20. The one or more non-transitory computer readable storage media of claim 18, wherein the instructions further cause the processor to:
dynamically designate the vehicle as a current leader of the platoon in response to one or more of:
a previous leader of the platoon leaving the platoon; and
determining that a previous leader of the platoon has poor network capabilities.
